(19) United States
(12) Patent Application Publication
(10) Pub. No.: US 2013/0305073 A1
(43) Pub. Date: Nov. 14, 2013

(54) CONTROLLING METHODS OF OPTICAL DISC DRIVE AND COMPUTER SYSTEM

(71) Applicant: Kun-Chang Chang, Hsinchu (TW)

(72) Inventor: Kun-Chang Chang, Hsinchu (TW)

(73) Assignee: Philips & Lite-on Digital Solutions Corporation, Taipei (TW)

(21) Appl. No.: 13/589,297

(22) Filed: Aug. 20, 2012

(30) Foreign Application Priority Data
May 10, 2012 (CN) 201210143288.9

(51) Int. Cl. G06F 1/26

(52) U.S. Cl. 713/324

(57) ABSTRACT

A controlling method of an optical disc drive includes the following steps. After an optical disc is loaded into the optical disc drive, a start-up procedure is performed to acquire a disc parameter and a disc information of the optical disc. Then, the optical disc drive enters a ready state. If a command from the computer system is received within a predetermined time interval, the command is executed and the optical disc drive enters the ready state again. If no command is received within the predetermined time interval, the optical disc drive enters an idle state corresponding to the presence of the optical disc. Then, the disc parameter, the disc information and a power index tag are written into a non-volatile memory, and a power-interruptible event is issued to the computer system.

This application claims the benefit of People's Republic of China Application Serial No. 201210143288.9, filed May 10, 2012, the subject matter of which is incorporated herein by reference.

### FIELD OF THE INVENTION

The present invention relates to a controlling method, and more particularly to a controlling method of an optical disc drive for allowing a computer system to stop providing power to the optical disc drive. The present invention also relates to a controlling method of a computer system for controlling power interruption and power supply of the optical disc drive.

### BACKGROUND OF THE INVENTION

As is well known, for most of today's computer systems, an optical disc drive is employed for allowing the computer system to access data from an optical disc. However, since the optical disc drive is directly connected with the computer system, if the computer system is powered on, the computer system may provide power to the optical disc drive to maintain normal operation of the optical disc drive. Even if the optical disc drive is in an idle state, the power provided by the computer system is still received by the control circuit within the optical disc drive. In other words, the continuous power consumption of the optical disc drive may waste electric energy.

Especially for a portable computer system (e.g. a notebook computer), the overall performance is highly dependent on the power consumption. For prolonging the use time of the built-in battery of the notebook computer, the current notebook computer may selectively stop providing power to the optical disc drive in order to avoid power consumption of the optical disc drive in the idle state.

Basically, the conventional computer system may firstly judge whether an optical disc has been loaded into the optical disc drive or not. If the computer system assures that no optical disc is loaded into the optical disc drive, the computer may consider that the optical disc drive is in the idle state corresponding to the absence of any optical disc. Meanwhile, the computer system stops providing power to the optical disc drive in order to reduce power consumption.

In a case that the user wants to load the optical disc, after an ejecting button of the optical disc drive again is pressed, the computer system provides power to the optical disc drive again. After the power is received by the optical disc drive, a hardware initiating process is performed. After the hardware initiating process is completed, the tray of the optical disc drive is ejected for allowing the user to load the optical disc, and the subsequent processes are performed.

In practice, even if no reading/writing operation is performed on the optical disc, the user may often forget to remove the optical disc from the optical disc drive. Under this circumstance, the optical disc drive is maintained in the idle state corresponding to the presence of the optical disc in the optical disc drive. Meanwhile, the conventional computer system may continuously provide power to the optical disc drive. The continuous power consumption of the optical disc drive may waste electric energy.

### SUMMARY OF THE INVENTION

The present invention provides a method for controlling power interruption and power supply of an optical disc drive when an optical disc is loaded into the optical disc drive. Consequently, when the optical disc drive is powered on again, the optical disc drive can quickly enter the ready state.

A first embodiment of the present invention provides a controlling method of an optical disc drive for allowing a computer system to stop providing power to the optical disc drive. The controlling method includes the following steps. After an optical disc is loaded into the optical disc drive, a start-up procedure is performed to acquire a disc parameter and a disc information of the optical disc. Then, the optical disc drive enters a ready state. If a command from the computer system is received within a predetermined time interval, executing the command and allowing the optical disc drive to enter the ready state again. If no command is received within the predetermined time interval, allowing the optical disc drive to enter an idle state corresponding to the presence of the optical disc. The disc parameter, the disc information and a power index tag are written into a non-volatile memory. Then, a power-interruptible event from the optical disc drive is issued to the computer system.

A second embodiment of the present invention provides a controlling method of a computer system for controlling power interruption and power supply of the optical disc drive. The controlling method includes the following steps. Firstly, a request is issued after the optical disc drive has been in an idle state for a predetermined time interval. When the request is received by the optical disc drive, a disc parameter and a disc information of an optical disc and a power index tag are written into a non-volatile memory. Then, a power-interruptible event is issued. When the power-interruptible event is received by the computer system, the computers system stops providing power to the optical disc drive.

Numerous objects, features and advantages of the present invention will be readily apparent upon a reading of the following detailed description of embodiments of the present invention when taken in conjunction with the accompanying drawings. However, the drawings employed herein are for the purpose of descriptions and should not be regarded as limiting.

### BRIEF DESCRIPTION OF THE DRAWINGS

The above objects and advantages of the present invention will become more readily apparent to those ordinarily skilled in the art after reviewing the following detailed description and accompanying drawings, in which:

FIG. 1A is a flowchart illustrating a controlling method of an optical disc drive according to an embodiment of the present invention;

FIG. 1B is a flowchart illustrating a controlling method of an optical disc drive according to another embodiment of the present invention; and

FIG. 2 is a flowchart illustrating a method of controlling the power of an optical disc drive by a computer system according to an embodiment of the present invention.

### DETAILED DESCRIPTION OF PREFERRED EMBODIMENTS

Generally, optical discs are classified into many types, for example CD discs, DVD discs, blue-Ray discs, or the like. These optical discs may be further divided into read-only optical discs, write-once optical discs or rewritable optical discs. After an optical disc is loaded into an optical disc drive, a start-up procedure is performed by the optical disc drive. During the start-up procedure is performed, the type of the optical disc is firstly realized, and then a disc parameter of the optical disc is acquired. Consequently, the disc information of the optical disc is read according to the disc parameter. After the disc parameter and the disc information are acquired and temporarily stored in the memory, the optical disc drive enters a ready state. Meanwhile, the computer system may perform a writing operation or a reading operation on the optical disc. As is well known, the start-up procedure of the optical disc drive is very time-consuming. For example, it usually takes about 5-10 seconds to acquire the disc parameter and the disc information.

In a case that the optical disc is not used, the optical disc may be removed by pushing an ejecting button of the optical disc drive. After the optical disc is removed, the disc parameter and the disc information stored in the memory are immediately deleted. Until another optic disc is loaded into the optical disc drive again, the start-up procedure is performed by the optical disc drive again. Consequently, the disc parameter and the disc information of this optical disc are acquired, and then the optical disc drive enters the ready state again.

Since the disc parameter and the disc information of the optical disc are stored in a dynamic random access memory, after the computer system stops providing power to the optical disc drive, the disc parameter and the disc information stored in the memory are also deleted. As previously described, after the computer system provides power to the optical disc drive again, it is important to avoid re-performing the start-up procedure in order to save time. For achieving this purpose, the conventional computer system should continuously provide power to the optical disc drive when the optical disc drive is in the idle state corresponding to the presence of an optical disc. In other words, the conventional controlling method is not power-saving.

For solving the above drawbacks, the present invention provides a method for controlling power interruption and power supply of an optical disc drive when the optical disc drive in an idle state corresponding to the presence of an optical disc. Before the computer system stops providing power to the optical disc drive, the disc parameter and the disc information are stored into the non-volatile memory of the optical disc drive. When the computer system provides power to the optical disc drive again, the disc parameter and the disc information previously stored in the non-volatile memory are read out from the non-volatile memory, so that the optical disc drive can quickly enter the ready state. In accordance with the present invention, the non-volatile memory is for example a flash memory, an electrically erasable programmable read-only memory (EEPROM), or the like.

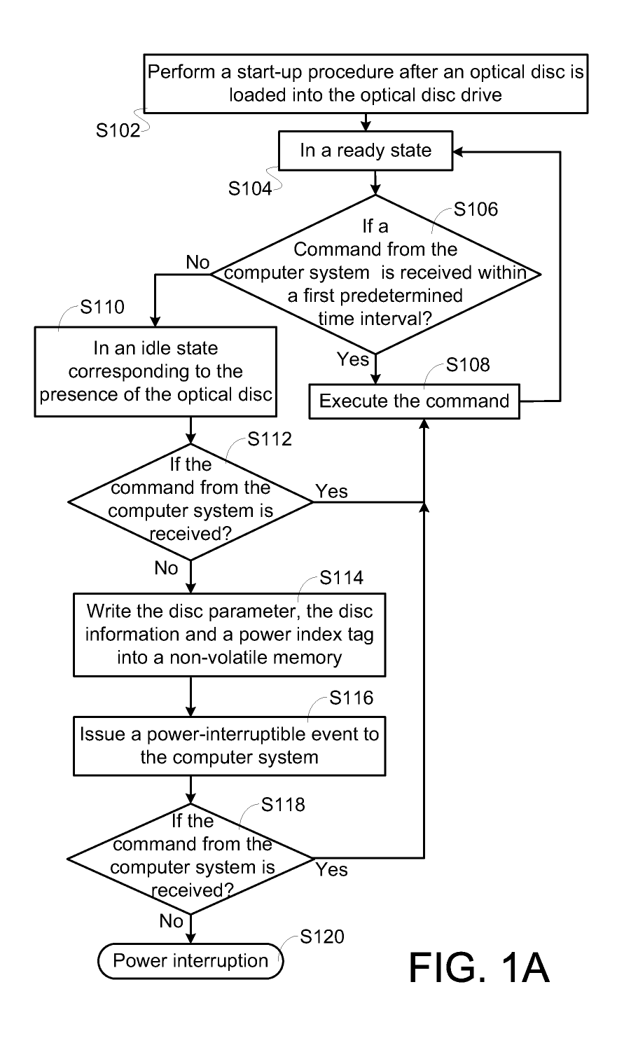

FIG. 1A is a flowchart illustrating a controlling method of an optical disc drive according to an embodiment of the present invention. The controlling method is performed by the optical disc drive in the situation that the optical disc is not removed. Firstly, a start-up procedure is performed after an optical disc is loaded into an optical disc drive (Step S102). During the start-up procedure is performed, the type of the optical disc is firstly realized, and then a disc parameter of the optical disc is acquired. Consequently, the disc information of the optical disc is read according to the disc parameter. After the start-up procedure is completed, the disc parameter and the disc information have been acquired and temporarily stored in a dynamic random access memory. Then, the optical disc drive enters a ready state (Step S104).

When the optical disc drive is in the ready state, the optical disc drive may judge whether a command from a computer system is received within a first predetermined time interval or not (Step S106). If the command from the computer system is received within the first predetermined time interval, the command is executed (Step S108). Generally, the optical disc may be accessed by the optical disc drive according to the command. After the command is executed, the optical disc drive enters the ready state again (Step S104) and waits for another command.

On the other hand, if no command from the computer system is received within the first predetermined time interval (Step S106), the optical disc drive in an idle state corresponding to the presence of the optical disc (Step S110).

When the optical disc drive in the idle state corresponding to the presence of the optical disc (Step S110), if a command from the computer system is received again (Step S112), the controlling method goes to the step S108 and the command is executed. On the other hand, if no command from the computer system is received in the step S112, the disc parameter, the disc information and a power index tag are written into a non-volatile memory of the optical disc drive (Step S114). Then, the optical disc drive issues a power-interruptible event to the computer system (Step S116). In accordance with the present invention, after the power-interruptible event is issued from the optical disc drive to the computer system, it means that the optical disc drive may be powered off at any time.

Of course, after the power-interruptible event is issued from the optical disc drive to the computer system (Step S116), if a command from the computer system is received again (Step S118), the controlling method goes to the step S108 and the command is executed. On the other hand, if no command from the computer system is received in the step S118, the power supplied to the optical disc drive is interrupted (Step S120).

From the above discussions, after the optical disc drive is in the idle state corresponding to the presence of the optical disc (Step S110) and before the optical disc drive is powered off (Step S120), if the command from the computer system is received by the optical disc drive, the command is executed (Step S108). Moreover, after the command is executed, the optical disc drive enters the ready state (Step S104).

FIG. 1B is a flowchart illustrating a controlling method of an optical disc drive according to another embodiment of the present invention. The controlling method is performed by the optical disc drive in the situation that the optical disc is not removed and the optical disc drive is powered on again. Firstly, the computer system provides power to the optical disc drive again (Step S132), and thus the optical disc drive performs a hardware initiating process (Step S134). Then, the step S136 is performed to judge whether a power index tag is stored in the non-volatile memory. If no power index tag is stored in the non-volatile memory, a start-up procedure is performed (Step S138). During the start-up procedure is performed, the type of the optical disc is firstly realized, and then a disc parameter of the optical disc is acquired. Consequently, the disc information of the optical disc is read according to the disc parameter. After the start-up procedure is completed, the disc parameter and the disc information have been acquired and temporarily stored in a dynamic random access memory. Then, the optical disc drive enters a ready state (Step S142).

On the other hand, if a power index tag is stored in the non-volatile memory, the disc parameter and the disc information are directly transmitted from the non-volatile memory to the dynamic random access memory (Step S140). Then, the optical disc drive enters a ready state (Step S142).

From the above discussions, before the power supplied to the optical disc drive is interrupted, not only the disc parameter and the disc information are stored in the non-volatile memory but also the power index tag is stored in the non-volatile memory. After the optical disc drive is started again, the optical disc drive will check whether the power index tag is stored in the non-volatile memory, thereby judging whether the disc parameter and the disc information can be read out from the non-volatile memory or not. Consequently, the optical disc drive can quickly enter the ready state without the need of performing the time-consuming start-up procedure.

Moreover, when the optical disc drive is about to be powered off, the optical disc drive issues a power-interruptible event to the computer system. In response to the power-interruptible event, the computer system stops providing power to the optical disc drive. It is of course that the compute system may directly request the optical disc drive to issue the power-interruptible event.

Moreover, during the power supplied to the optical disc drive is interrupted, if the optical disc is ejected from the optical disc drive, the power index tag stored in the non-volatile memory will be deleted. Consequently, when the optical disc drive detects that no power index tag is stored in the non-volatile memory, the start-up procedure is performed, and the disc parameter and the disc information are read out from the new optical disc. In other words, the power supplied to the optical disc drive may be completely interrupted without the need of retaining small quantity of electric energy to detect whether the optical disc is ejected or not. Under this circumstance, the power-saving purpose can be further achieved.

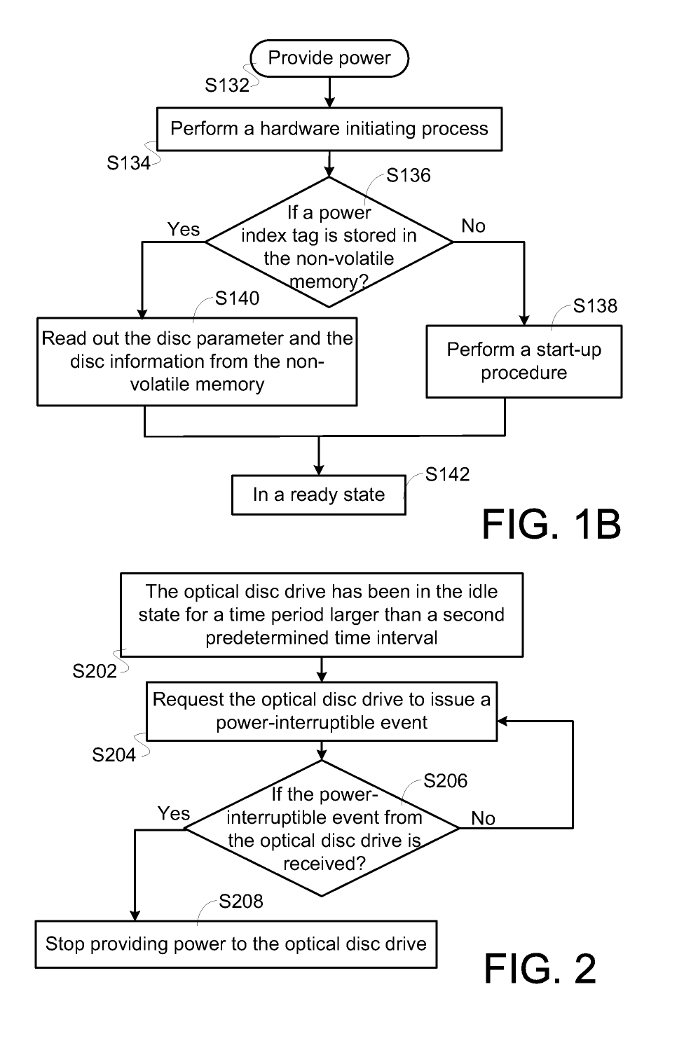

FIG. 2 is a flowchart illustrating a method of controlling the power of an optical disc drive by a computer system according to an embodiment of the present invention. After the optical disc drive has been in the idle state for a time period larger than a second predetermined time interval (Step S202), the computer system may request the optical disc drive to issue a power-interruptible event (Step S204). Then, the computer system waits for the power-interruptible event and judges whether the power-interruptible event from the optical disc drive is received or not (Step S206).

When the power-interruptible event from the optical disc drive is received by the computer system, the computer system stops providing power to the optical disc drive (Step S208). On the other hand, if the power-interruptible event from the optical disc drive is not received by the computer system, the computer system continuously requests the optical disc drive to issue the power-interruptible event (Step S204).

Of course, when the request from the computer system to request the optical disc drive to issue a power-interruptible event is received by the optical disc drive, if an optical disc is loaded into the optical disc drive, the steps S114 and S116 as shown in FIG. 1A may be directly performed by the optical disc drive. That is, when the request from the computer system to request the optical disc drive to issue a power-interruptible event is received by the optical disc drive, the disc parameter, the disc information and the power index tag are written into the non-volatile memory of the optical disc drive. Then, the optical disc drive issues a power-interruptible event to the computer system. Then, the optical disc drive may be powered off by the computer system at any time.

From the above discussions, after no accessing operation has been performed by the optical disc drive and the optical disc drive has been in the idle state for the second predetermined time interval, the computer system may request the optical disc drive to issue a power-interruptible event. When the optical disc drive is in the idle state corresponding to the presence of the optical disc and the power-interruptible event is issued, it means that the backups of the disc parameter and the disc information have been stored into the non-volatile memory. Under this circumstance, the computer system stops providing the power to the optical disc drive. Of course, if the optical disc drive is in the idle state corresponding to the absence of the optical disc, the computer system may stop providing the power to the optical disc drive without the need of creating the backups of the parameter and the disc information.

From the above description, the present invention provides a method for controlling power interruption and power supply of an optical disc drive when the optical disc drive in an idle state corresponding to the presence of an optical disc. Before the computer system stops providing power to the optical disc drive, the disc parameter and the disc information are stored into the non-volatile memory of the optical disc drive. When the computer system provides power to the optical disc drive again, the disc parameter and the disc information previously stored in the non-volatile memory are read out from the non-volatile memory, so that the optical disc drive can quickly enter the ready state.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A controlling method of an optical disc drive for allowing a computer system to stop providing power to the optical disc drive, the controlling method comprising steps of:
performing a start-up procedure after an optical disc is loaded into the optical disc drive, thereby acquiring a disc parameter and a disc information of the optical disc;
allowing the optical disc drive to enter a ready state;
if a command from the computer system is received within a predetermined time interval, executing the command and allowing the optical disc drive to enter the ready state again;
if no command is received within the predetermined time interval, allowing the optical disc drive to enter an idle state corresponding to the presence of the optical disc;
writing the disc parameter, the disc information and a power index tag into a non-volatile memory; and
issuing a power-interruptible event from the optical disc drive to the computer system.

2. The controlling method as claimed in claim 1, wherein after the optical disc drive is in the idle state corresponding to the presence of the optical disc and before the power provided to the optical disc drive is interrupted, if the command from the computer system is received by the optical disc drive, the optical disc drive executes the command and then enters the ready state again.

3. The controlling method as claimed in claim 1, wherein during the start-up procedure is performed, a type of the optical disc is firstly realized, and then the disc parameter and the disc information are acquired.

4. The controlling method as claimed in claim 1, wherein the non-volatile memory is a flash memory or an electrically erasable programmable read-only memory.

5. The controlling method as claimed in claim 1, wherein after the power is received by the optical disc drive again, the controlling method further comprises steps of:
performing a hardware initiating process;
if no power index tag is stored in the non-volatile memory, performing a start-up procedure; and
if the power index tag is stored in the non-volatile memory, reading out the disc parameter and the disc information from the non-volatile memory and allowing the optical disc drive to enter the ready state again.

6. The controlling method as claimed in claim 5, wherein if the power index tag is stored in the non-volatile memory, the disc parameter and the disc information are read out from the non-volatile memory and transmitted to a dynamic random access memory.

7. A controlling method of a computer system for controlling power interruption and power supply of the optical disc drive, the controlling method comprising steps of:
issuing a request after the optical disc drive has been in an idle state for a predetermined time interval;
writing a disc parameter and a disc information of an optical disc and a power index tag into a non-volatile memory when the request is received by the optical disc drive;
issuing a power-interruptible event; and
stopping providing power to the optical disc drive when the power-interruptible event is received by the computer system.

8. The controlling method as claimed in claim 7, wherein after the computer system provides power to the optical disc drive again, the controlling method further comprises steps of:
performing a hardware initiating process;
if no power index tag is stored in the non-volatile memory, performing a start-up procedure; and
if the power index tag is stored in the non-volatile memory, reading the disc parameter and the disc information from the non-volatile memory and allowing the optical disc drive to enter the ready state again.

9. The controlling method as claimed in claim 8, wherein during the start-up procedure is performed, a type of the optical disc is firstly realized, and then the disc parameter and the disc information are acquired.

10. The controlling method as claimed in claim 8, wherein if the power index tag is stored in the non-volatile memory, the disc parameter and the disc information are read out from the non-volatile memory and transmitted to a dynamic random access memory.
